(19) United States
(12) Patent Application Publication
(10) Pub. No.: US 2011/0146999 A1
(43) Pub. Date: Jun. 23, 2011

(54) Method and Apparatus for Dewatering Using Methane

(75) Inventor: Mark STANTON, Boyle (CA)

(73) Assignee: FLO-SOLUTIONS LTD., Boyle (CA)

(21) Appl. No.: 12/970,409

(22) Filed: Dec. 16, 2010

Related U.S. Application Data
(60) Provisional application No. 61/287,166, filed on Dec. 16, 2009.

(51) Int. Cl. E21B 37/08; B67D 7/84

(52) U.S. Cl. 166/311; 222/129

(57) ABSTRACT

A method of purging fluids from a gas well wellbore having a tubing string and casing in fluid communication by introducing pressurized methane gas into either the tubing string or casing of the wellbore at the well surface to displace the fluids out of the wellbore through the counterpart casing or tubing string of the wellbore, and a system for storage and delivery of pressurized methane gas in which an assembly of aligned gas cylinders, each cylinder having a valve at one end, the valves contained within a manifold at one end of the assembly, the manifold having a single valve to control flow of the gas into and out of the cylinders of the assembly for delivery of the pressurized gas into a pipeline or wellbore.

### FIELD OF THE INVENTION

The present invention relates to gas wells, and in particular, to dewatering of gas wells.

### BACKGROUND OF THE INVENTION

A common problem with low pressure, low production gas wells is liquid loading. Ideally, wells require a critical gas lift rate of approximately 7-10 e3m3/day for tubing having a diameter of 60.3 mm. If critical gas lift rates drop below this threshold rate, a gas well may begin to experience liquid loading. Eventually, liquid loading may result in the hydrostatic head of the fluid surpassing the bottomhole pressure. The resulting effect is a well in which the gas cannot be lifted to the surface for extraction.

It is well known in the prior art to address the problem of liquid loading by purging the wellbore clean of any fluid through the circulation of nitrogen gas down the wellbore to displace any liquid for collection into a tank or other container at the well surface.

The present invention provides a method and apparatus which improves upon the established practice of dewatering gas wells utilizing nitrogen gas. Other applications of the technology are also identified and described.

### SUMMARY OF THE INVENTION

There is provided a method of purging fluids from a gas well wellbore having a tubing string and casing in fluid communication, comprising introducing pressurized methane gas into either the tubing string or casing of the wellbore at the well surface to displace the fluids out of the wellbore through the counterpart casing or tubing string of the wellbore.

The gas well may be a dual completion gas well having an upper zone portion and a lower zone portion separated one from the other by a plug, wherein the methane gas may be circulated within the upper zone portion of the tubing string and casing. Cleaning chemicals or condensates may be circulated through the well to remove asphaltenes, then circulating pressurized methane gas through the pipeline to remove the cleaning chemicals or condensates.

The invention also provides a method of cleaning a pipeline by purging the pipeline by circulating pressurized methane gas through the pipeline. In one embodiment, a pig may be introduced into a selected portion of the pipeline and pressurized methane gas introduced into the pipeline behind the pig to move the pig through the selected portion of the pipeline. The methane gas may be recovered for reuse.

In one of its aspects, the invention provides a system for storage and delivery of pressurized gas, comprising an assembly of aligned gas cylinders, each cylinder having a valve at one end, the valves contained within a manifold at one end of the assembly, the manifold having a single valve to control flow of the gas into and out of the cylinders of the assembly. The gas cylinders may be connected in series such that gas may be delivered from or to a selected number of gas cylinders simultaneously.

In one embodiment, the assembly may be a unitary structure which may be transported to and from a pipeline or well site. In an alternate embodiment, the assembly may be built into a vehicle for transportation to and from a pipeline or well site.

Preferably, the assembly comprises 26 natural gas cylinder having a capacity of 900 cubic meters of methane gas at approximately 18,300 kilopascals. The methane gas may be dispensed through the manifold from a selected number of cylinders simultaneously into a pipeline or wellbore.

### BRIEF DESCRIPTION OF THE DRAWINGS

A detailed description of the preferred embodiments is provided below by way of example only and with reference to the following drawings, in which:

FIG. 1 is a perspective view of the apparatus of the present invention;

FIG. 2 is a schematic of the method of one embodiment of the present invention for use with single completion well;

FIG. 3 is a schematic of the method of another embodiment of the present invention for use with single completion well;

FIG. 4 is a schematic of the method of another embodiment of the present invention for use with dual completion well;

FIG. 5 is a schematic of the method of another embodiment of the present invention for use with dual completion well;

FIG. 6 is a perspective view of the cylinder manifold of the present invention; and

FIG. 7 is a perspective view of attachment of the apparatus of the present invention to a well head.

In the drawings, one embodiment of the invention is illustrated by way of example. It is to be expressly understood that the description and drawings are only for the purpose of illustration and as an aid to understanding, and are not intended as a definition of the limits of the invention.

### DETAILED DESCRIPTION OF THE INVENTION

According to the present invention, natural gas, or methane, may be used to dewater wellbores which have become hydrostatically loaded with liquids. According to one embodiment of the method of the invention, methane gas is transported in pressurized gas cylinders to the well site, where the gas is then injected into and circulated down the wellbore to displace any existing wellbore fluids allowing their removal from the well.

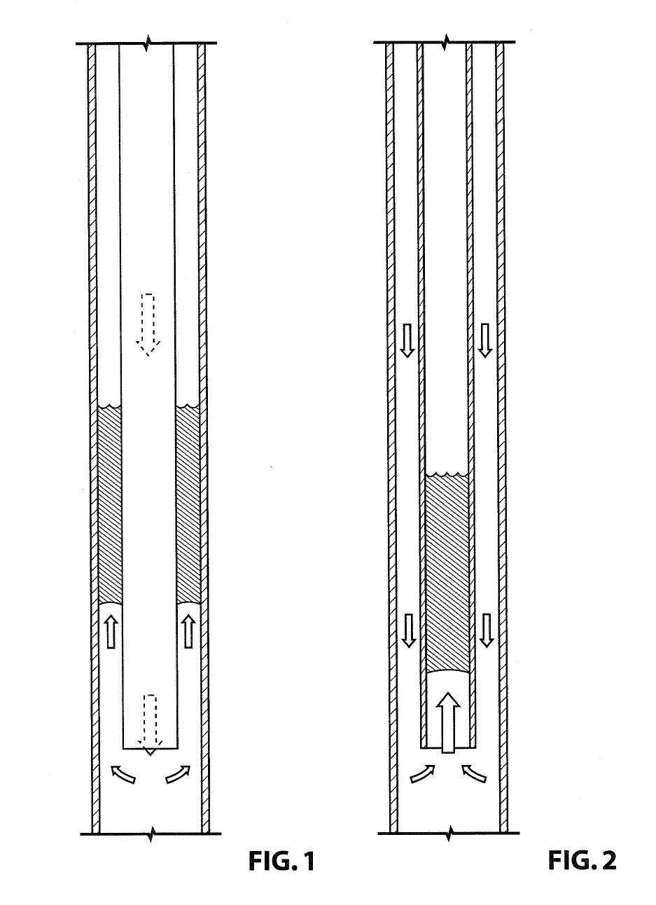

For the effective operation of the method of the present invention, ideally the tubing string and the casing are in communication with each other. According to one embodiment depicted in FIG. 1, the methane gas is injected into the tubing at the well surface, and circulated down the tubing. The introduction of methane gas displaces the fluid in the well, causing the fluid to circulate up the casing to the well surface. In an alternate embodiment of the method of the present invention, as shown in FIG. 2, the methane gas may be injected into the casing, causing the fluid in the well to be displaced upwardly along the tubing string. The elimination of fluid from the tubing string enhances the potential productivity of the well.

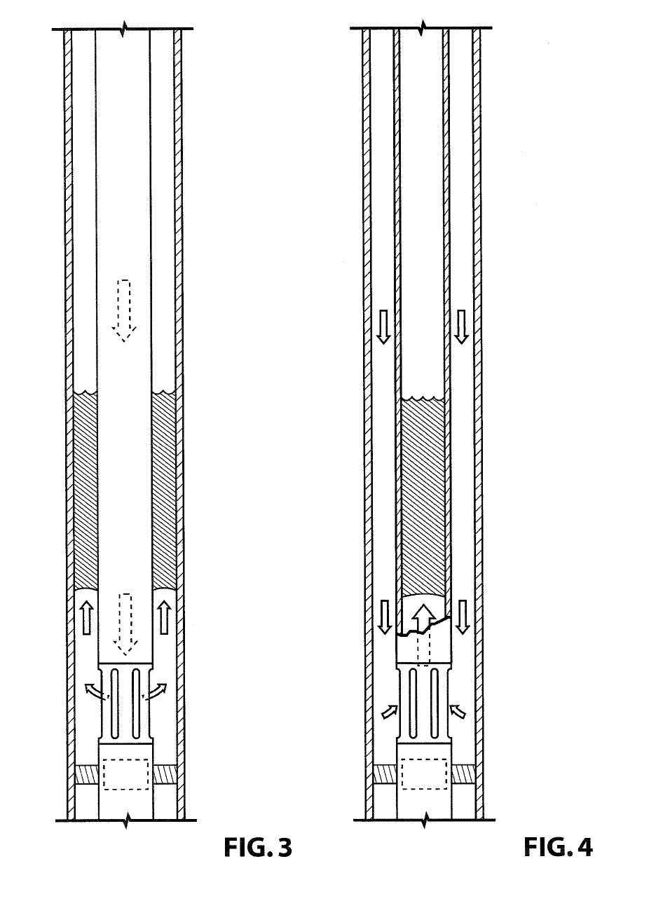

FIGS. 1 and 2 show single completion wells. The present invention may also be used with dual completion wells, as depicted in FIGS. 3 and 4, in which methane gas is introduced into the tubing or the casing, respectively, in the upper zone of the dual completion well and causes the liquid to be displaced and moved upwardly within the upper zone.

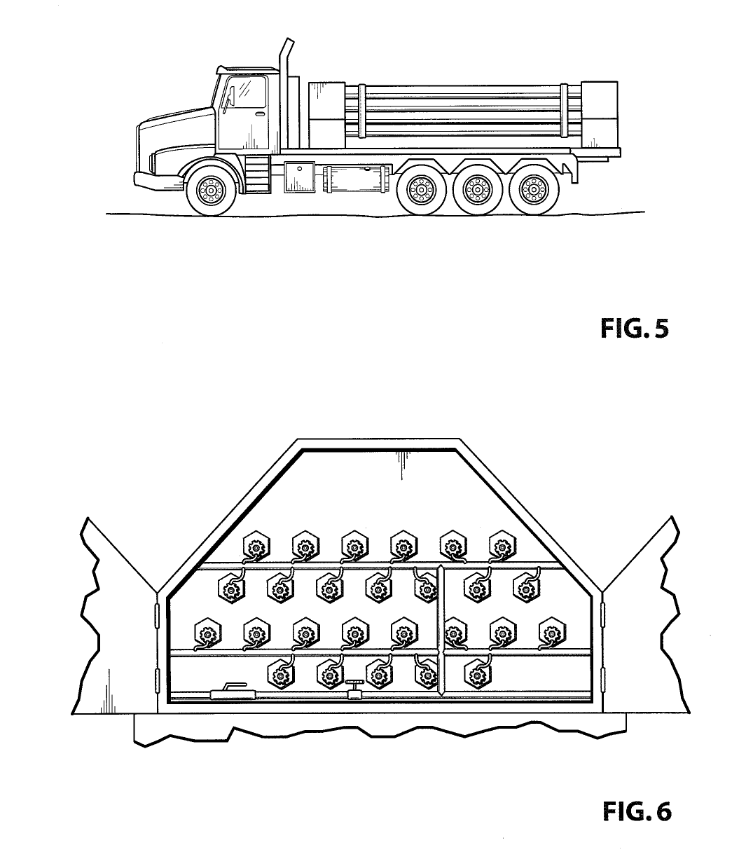

Transportation of the methane gas to the well site may be achieved using pressurized methane gas cylinders connected to containment and dispensing equipment. In one embodiment, the gas cylinders and equipment may be mounted on a trailer towable by a truck. In a preferred embodiment, the cylinders and equipment may be mounted on a flatbed truck directly, as depicted in FIG. 5, or may be transported to a well site by helicopter or other means. Preferably, the vehicle used to transport the gas cylinders and support equipment is adapted for operation in severe cold and hot weather conditions, and for use on poor quality roads.

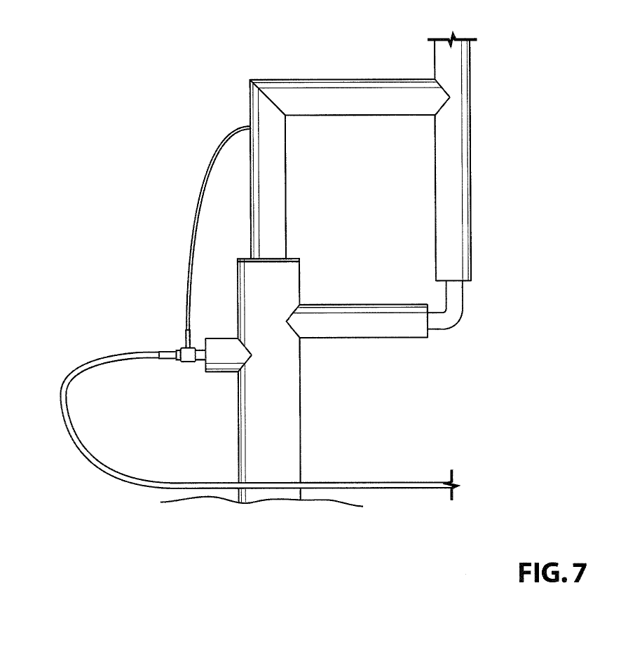

In a preferred embodiment of the apparatus of the present invention, the apparatus comprises 26 natural gas cylinders capable of holding a total of 900 m3 of natural gas at approximately 18,300 kilopascals. The cylinders are assembled into a manifold as depicted in FIG. 6, permitting easy access to each cylinder valve. One or more cylinders may be opened and the flow of gas into the well or controlled from a single dispensing valve. Preferably, the gas cylinders are connected in series to allow the pressurized gas to flow freely through a manifold from any or all the cylinders. Typically, each shallow well will require approximately 6-8 cylinders to displace any wellbore fluid.

The cylinders may be filled in approximately 30 minutes using a compressor located at a pipeline compressor station using a 95 HP compressor, or similar. The manifold assembly permits filling of one or more cylinders simultaneously. A short filling time is desirable as it allows for the apparatus of the invention to be deployed to multiple locations in one day. Preferably, the apparatus is attached to the compressor using a high pressure hose rated for 30,000 KPa. Once delivered to the well, the apparatus may be connected using a high pressure hose to the wellhead, as depicted in FIG. 7.

The method and apparatus of the present invention provides several benefits to dewatering natural gas wells. The apparatus and method of the present invention may be fully operated and carried out by one person, including filling, transportation and dewatering operations, minimizing labour costs. Importantly, the methane gas used to dewater low pressure gas wells may be recovered from the pipeline. In prior art approaches using nitrogen gas, the nitrogen itself would need to be purged from the well following dewatering, as nitrogen gas is not combustible. The use of natural gas in the present invention is facilitated by the widespread availability of compressor stations along gas pipelines in the regions where gas wells may need dewatering, for example in the Canadian provinces of Alberta, British Columbia and Saskatchewan, making replenishing the gas cylinders simple.

The use of the method and apparatus of the present invention greatly reduces swabbing costs. In addition, pipeline pigging operations can be undertaken with less labour and time as the high pressure gas in the apparatus of the present invention is capable of moving a pig a long distance in a relatively short period of time, thereby reducing labour costs and downtime.

In particular, low producing gas wells which would not be economically feasible in view of swabbing or reactivation costs may be put back into production using the method and apparatus of the present invention for a fraction of the cost of swabbing or reactivation. Further, chemical treatments on low producing wells may show an improved profitability by eliminating the high cost of a third party pressure unit.

According to alternate embodiments of the present invention, methane gas may be injected into pipelines for cleaning stagnant pipelines, and into flowing gas wells for chemical treatments on those gas wells. In order to assist in pipeline maintenance, the present invention may be used to clean fluid from gas pipelines. A pig may be placed in the pipeline, and then the pig pushed along the pipeline by the pressurized natural gas introduced by the apparatus of the present invention. As many of the gas pipelines operate at low pressure and are connected to low pressure gas wells, pigging a line according to prior art methods may require several hours. In addition, for suspended gas pipelines, there may be no producing gas wells available to provide a pressure source for pigging, requiring use of an external pressure source. Using the apparatus and method of the present invention, significant time savings may be achieved, and lines which could not be cleaned using prior art techniques may be cleaned using the present invention.

Occasionally, some gas wells may develop a buildup of heavy tar-like materials known as asphaltenes. This build up can occur at the sandface of the wellbore perforations, thereby impeding gas production. Using the apparatus and method of the present invention, these wells may be treated with chemicals or condensate. According to this embodiment of the method of the invention, the selected chemical or condensate is introduced down the wellbore and circulated until it is identified near the well perforations. The apparatus is then attached to the well and the high pressure methane gas is injected through the well, forcing the chemical or condensate into the formation in order to break down the asphaltenes buildup. The use of the present invention for this application enhances well production at a reduced cost relative to prior art chemical treatments.

It is to be understood that all matter herein set forth or shown in the accompanying drawings is to be interpreted as illustrative and not in a limiting sense. It will be appreciated by those skilled in the art that other variations of the preferred embodiment may also be practiced without departing from the scope of the invention.

1. A method of purging fluids from a gas well wellbore having a tubing string and casing in fluid communication, comprising introducing pressurized methane gas into either the tubing string or casing of the wellbore at the well surface to displace the fluids out of the wellbore through the counterpart casing or tubing string of the wellbore.

2. The method of claim 1 wherein the gas well is a dual completion gas well having an upper zone portion and a lower zone portion separated one from the other by a plug, wherein the methane gas is circulated within the upper zone portion of the tubing string and casing.

3. The method of claim 1, further comprising the step of circulating cleaning chemicals or condensates through the well to remove asphaltenes, then circulating pressurized methane gas through the pipeline to remove the cleaning chemicals or condensates.

4. The method of claim 2, further comprising the step of circulating cleaning chemicals or condensates through the well to remove asphaltenes, then circulating pressurized methane gas through the pipeline to remove the cleaning chemicals or condensates.

5. A method of cleaning a pipeline comprising purging the pipeline by circulating pressurized methane gas through the pipeline.

6. The method of claim 4, further comprising introducing a pig into a selected portion of the pipeline and introducing pressurized methane gas into the pipeline behind the pig to move the pig through the selected portion of the pipeline.

7. A system for storage and delivery of pressurized gas, comprising an assembly of aligned gas cylinders, each cylinder having a valve at one end, the valves contained within a manifold at one end of the assembly, the manifold having a single valve to control flow of the gas into and out of the cylinders of the assembly.

8. The system of claim 7 wherein the gas cylinders are connected in series such that gas may be delivered from or to a selected number of gas cylinders simultaneously.

9. The system of claim 7, wherein the assembly is a unitary structure which may be transported to and from a pipeline or well site.

10. The system of claim 7, wherein the assembly is built into a vehicle for transportation to and from a pipeline or well site.

11. The system of claim 7, wherein the plurality of cylinders comprises 26 natural gas cylinders.

12. The system of claim 11, wherein methane gas may be dispensed from a selected number of cylinders simultaneously.
